(19) United States
(12) Patent Application Publication
(10) Pub. No.: US 2011/0129648 A1
(43) Pub. Date: Jun. 2, 2011

(54) GLASS SHEET ARTICLE WITH DOUBLE-TAPERED ASYMMETRIC EDGE

(76) Inventor: Yabei Gu, Painted Post, NY (US)

(21) Appl. No.: 12/903,575

(22) Filed: Oct. 13, 2010

Related U.S. Application Data
(60) Provisional application No. 61/264,910, filed on Nov. 30, 2009.

(51) Int. Cl. B32B 3/02; B32B 17/06; C03C 21/00

(52) U.S. Cl. 428/157; 65/30.14; 65/106

(57) ABSTRACT

A glass sheet article includes a glass sheet having an upper surface and a lower surface. The upper surface terminates in a tapered upper end, and the lower surface terminates in a tapered lower edge. The taper profile of the tapered upper edge is different from the taper profile of the tapered lower edge. The tapered upper edge and the tapered lower edge intersect to form a double-tapered asymmetric edge.

### CROSS-REFERENCE TO RELATED APPLICATIONS

This application claims the benefit of priority of U.S. Provisional Application Ser. No. 61/264,910 filed on Nov. 30, 2009.

### TECHNICAL FIELD

The invention relates generally to glass sheet articles and more particularly to techniques for strengthening the edges of glass sheets.

### BACKGROUND

In this disclosure, the term “glass sheet article” is used to describe a glass article made from a glass sheet. Such a glass article has an edge or rim. Edges are inherently the weakest parts of glass sheet articles. The edges are usually prepared using techniques such as scoring and breaking, which disrupt the continuum of the glass structure. For an edge of a glass sheet that has been prepared via scoring and breaking, a tiny crack at the edge of the glass sheet can easily propagate across the glass sheet, rendering the glass sheet useless or at least less appealing. Typically, the edge of the glass sheet would have to be covered to protect it against external loading that can result in such cracks. However, electronic device manufacturers are pushing for edge-to-edge glass sheet articles, for example, for use as covers for electronic devices. In edge-to-edge glass sheet articles, the edge of the glass sheet article would be uncovered and would be directly exposed to the environment. This would require that the edge must be able to withstand a reasonable amount of external loading. The present invention relates to such an edge-to-edge glass sheet article.

### SUMMARY

In a first aspect, the present invention relates to a glass sheet article which comprises: a glass sheet having an upper surface and a lower surface, wherein the upper surface terminates in a tapered upper edge and the lower surface terminates in a tapered lower edge, wherein a taper profile of the tapered upper edge is different from a taper profile of the tapered lower edge, and wherein the tapered upper edge and the tapered lower edge intersect to form a double-tapered asymmetric edge.

In certain embodiments of the first aspect of the present invention, an induced stress response of the tapered upper edge to a loading condition is different from an induced stress response of the tapered lower edge to the same loading condition.

In certain embodiments of the first aspect of the present invention, at least one of the tapered upper edge and tapered lower edge is curved.

In certain embodiments of the first aspect of the present invention, the tapered upper edge and the tapered lower edge are both curved.

In certain embodiments of the first aspect of the present invention, at least one of the tapered upper edge and tapered lower edge is beveled.

In certain embodiments of the first aspect of the present invention, the glass sheet is flat.

In certain embodiments of the first aspect of the present invention, the glass sheet is curved.

In certain embodiments of the first aspect of the present invention, the glass sheet is asymmetric when viewed from at least one of the upper surface and lower surface.

In certain embodiments of the first aspect of the present invention, the glass sheet is made of an alkali-containing glass.

In certain embodiments of the first aspect of the present invention, the alkali-containing glass comprises: 60-72 mol % SiO₂; 9-16 mol % Al₂O₃; 5-12 mol % B₂O₃; 8-16 mol % Na₂O; and 0-4 mol % K₂O, wherein the ratio

$$\frac{{Al}_{2} {O}_{3} ( mol \% ) + {B}_{2} {O}_{3} ( mol \% )}{\sum alkali metal modifiers ( mol \% )} > 1 ,$$

where the alkali metal modifiers are alkali metal oxides.

In certain embodiments of the first aspect of the present invention, the alkali-containing glass comprises: 61-75 mol % SiO₂; 7-15 mol % Al₂O₃; 0-12 mol % B₂O₃; 9-21 mol % Na₂O; 0-4 mol % K₂O; 0-7 mol % MgO; and 0-3 mol % CaO.

In certain embodiments of the first aspect of the present invention, the alkali-containing glass comprises: 60-70 mol % SiO₂; 6-14 mol % Al₂O₃; 0-15 mol % B₂O₃; 0-15 mol % Li₂O; 0-20 mol % Na₂O; 0-10 mol % K₂O; 0-8 mol % MgO; 0-10 mol % CaO; 0-5 mol % ZrO₂; 0-1 mol % SnO₂; 0-1 mol % CeO₂; less than 50 ppm As₂O₃; and less than 50 ppm Sb₂O₃; wherein 12 mol %≦Li₂O+Na₂O+K₂O≦20 mol % and 0 mol %≦MgO+CaO≦10 mol %.

In certain embodiments of the first aspect of the present invention, the alkali-containing glass is chemically strengthened by ion exchange.

In certain embodiments of the first aspect of the present invention, the glass sheet is coated with a glass coating.

In certain embodiments of the first aspect of the present invention, the glass coating comprises titanium-doped silica.

In a second aspect of the present invention, a method of making a glass sheet article comprises: providing a glass sheet having an upper surface and a lower surface, the upper surface having an upper edge, the lower surface having a lower edge; tapering the upper edge towards the lower edge using a first taper profile; and tapering the lower edge towards the upper edge using a second taper profile, the second taper profile being different form the first taper profile, the upper edge and the lower edge intersecting to form a double-tapered asymmetric edge.

In certain embodiments of the second aspect of the present invention, the method comprises subjecting the glass sheet with the double-tapered asymmetric edge to an ion-exchange process.

These and other aspects and embodiments of the present invention will be apparent from the following description and the appended claims.

### BRIEF DESCRIPTION OF DRAWINGS

The following is a description of the figures in the accompanying drawings. The figures are not necessarily to scale, and certain features and certain views of the figures may be shown exaggerated in scale or in schematic in the interest of clarity and conciseness.

FIG. 1 is a perspective view of a glass sheet article with a double-tapered asymmetric edge.

FIG. 2 is a cross-section of the glass sheet article of FIG. 1 along line 2-2.

FIG. 3 is a top view of a glass sheet article having a double-tapered asymmetric edge.

FIG. 4 is a cross-section of a glass sheet article having a double-tapered asymmetric edge made of a curved edge and a beveled edge.

FIG. 5 is a cross-section of a glass sheet article having a double-tapered asymmetric edge made of beveled edges.

FIG. 6 is a cross-section of a curved glass sheet article having a double-tapered asymmetric edge.

FIG. 7 is a cross-section of a glass sheet having a straight edge (comparative example).

FIG. 8 is a cross-section of a glass sheet having a symmetric chamfered edge (comparative example).

FIG. 9 is a cross-section of a glass sheet having a symmetric bull-nose edge (comparative example).

FIG. 10 shows stress distribution in the glass sheet article of FIG. 2 under ion-exchange process conditions.

FIG. 11 shows stress distribution in the glass sheet article of FIG. 9 under ion-exchange process conditions.

FIG. 12 shows stress distribution in the glass sheet article of FIG. 8 under ion-exchange process conditions.

FIG. 13 shows the stress distribution in the glass sheet article of FIG. 7 under ion-exchange process conditions.

FIG. 14 is a schematic view of a four-point bending test model.

FIG. 15 shows the stress response of the glass sheet article of FIG. 2 to four-point bending conditions.

FIG. 16 shows the stress response of the glass sheet article of FIG. 9 to four-point bending conditions.

FIG. 17 shows the stress response of the glass sheet article of FIG. 8 to four-point bending conditions.

FIG. 18 shows the stress response of the glass sheet article of FIG. 7 to four-point bending conditions.

FIG. 19 is a schematic view of an edge drop test model.

FIG. 20 shows the stress response of the glass sheet article of FIG. 8 under edge drop conditions.

FIG. 21 shows the stress response of the glass sheet article of FIG. 9 under edge drop conditions.

FIG. 22 shows the stress response of the glass sheet article of FIG. 2 under edge drop conditions.

### DETAILED DESCRIPTION

The present invention will now be described in detail, with reference to the accompanying drawings. In this detailed description, numerous specific details may be set forth in order to provide a thorough understanding of the invention. However, it will be apparent to one skilled in the art when the invention may be practiced without some or all of these specific details. In other instances, well-known features and/or process steps may not be described in detail so as not to unnecessarily obscure the invention. In addition, like or identical reference numerals may be used to identify common or similar elements.

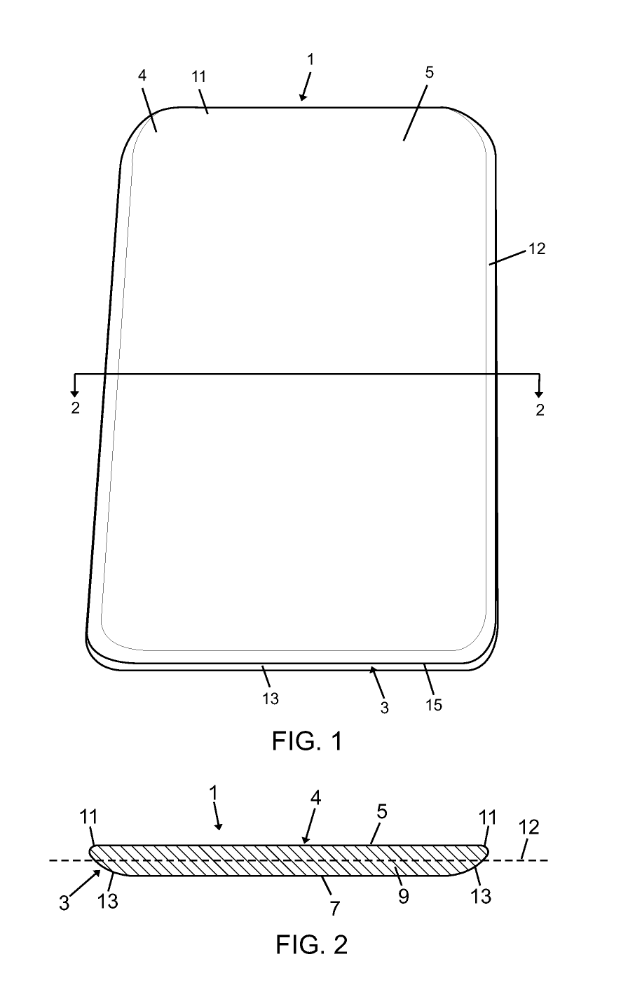

FIGS. 1 and 2 illustrate a glass sheet article 1 having a double-tapered asymmetric edge 3 according to certain aspects of the present invention. FIG. 1 is a perspective view of the glass sheet article 1, while FIG. 2 is a vertical cross-section of the glass sheet article 1. FIG. 2 represents a vertical cross-section of the glass sheet article 1 along the width of the glass sheet article 1. A vertical cross-section of the glass sheet article 1 along the length of the glass sheet article 1 would be similar to the one shown in FIG. 2 and is therefore not shown separately. The glass sheet article 1 includes a glass sheet 4 having an upper surface 5 and a lower surface (7 in FIG. 2). The lower surface 7 is opposite to the upper surface 5 and is essentially parallel to the upper surface 5. In this disclosure, the terms “upper” and “lower” are arbitrary. Either of the upper or lower surface 5, 7 of the glass sheet 4 may be the top or bottom surface of the glass sheet article 1.

The upper surface 5 of the glass sheet 4 terminates in an upper edge 11, and the lower surface 7 terminates in a lower edge 13. As seen more clearly in FIG. 2, the upper edge 11 tapers towards the lower edge 13 with a first taper profile, and the lower edge 13 tapers towards the upper edge 11 with a second taper profile. The first taper profile and the second taper profile are different. The upper edge 11 and lower edge 13 meet or intersect, as indicated generally at 15 in FIG. 1, to form the double-tapered asymmetric edge 3 of the glass sheet article 1. The asymmetricity of the edge 3 comes from the first taper profile of the upper edge 11 and the second taper profile of the lower edge 13 being different. The double-tapered asymmetricity of the edge 3 is relative to a plane parallel to the upper surface 5 and the lower surface 7. Alternatively, as shown in FIG. 2, the double-tapered asymmetricity of the edge 3 is relative to a horizontal centerline 12 of a vertical cross-section of the glass sheet 4.

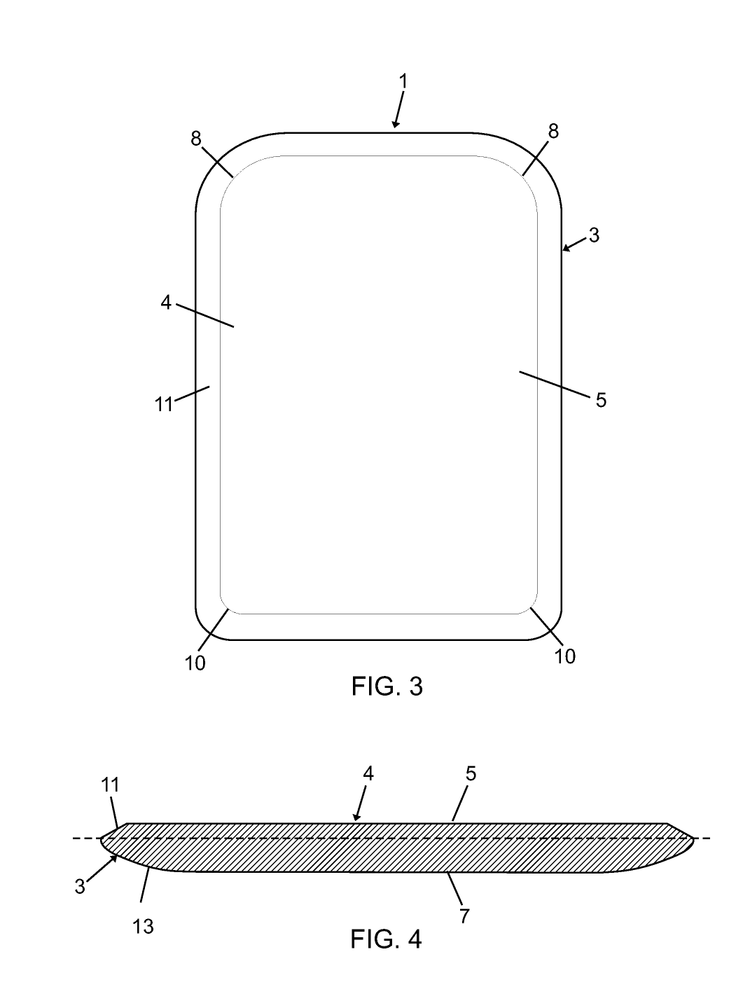

Because of the double-tapered asymmetric edge 3, the glass sheet article 1 will appear asymmetric when viewed from the edge 3. The glass sheet article 1 may be symmetric or asymmetric when viewed from the upper surface 5, depending on whether the upper surface 5 is symmetric or asymmetric. Similarly, the glass sheet article 1 may be symmetric or asymmetric when viewed from the lower surface 7, depending on whether the lower surface 7 is symmetric or asymmetric. Consider FIG. 3, for example. FIG. 3 shows an upper surface view of a glass sheet article 1 (FIG. 3 may or may not correspond to the top view of FIG. 1). In FIG. 3, the upper surface 5 is generally rectangular in shape with upper rounded corners 8 and lower rounded corners 10. The radius of curvature of the upper rounded corners 8 is different from that of the lower rounded corners 10, making the upper surface 5 asymmetric. Note that the upper edge 11 simply traces the periphery of the upper surface 5 so that the glass sheet article 1, when viewed from the upper surface 5, is asymmetric. The example of FIG. 3 is presented only to show that the glass sheet article 1 may be asymmetric in multiple dimensions.

FIG. 2 shows a cross-section of the glass sheet article 1 of FIG. 1, with a thickness of glass 9 between the upper surface 5 and the lower surface 7 of the glass sheet 4. The upper edge 11 and the lower edge 13, which intersect to form the double-tapered asymmetric edge 3, are also shown. In this cross-section, the tapered upper edge 11 is curved, and the tapered lower edge 13 is curved. To achieve the double-tapered asymmetricity of the edge 3 of the glass sheet article 1, the radius of curvature of the tapered upper edge 11 has to be different from the radius of curvature of the tapered lower edge 13. In FIG. 2, the radius of curvature of the tapered lower edge 13 is larger than the radius of curvature of the tapered upper edge 11. In other embodiments, the opposite may be true, i.e., the radius of curvature of the tapered upper edge 11 may be larger than the radius of curvature of the tapered lower edge 13. As previously mentioned, the terms “upper” and “lower” do not have any special (functional) meanings. The upper edge 11 and the lower edge 13, because of their different shape profiles, will have different induced stress responses to the same external loading condition. The more asymmetric the shape profiles of the upper edge 11 and lower edge 13, the more pronounced may be the difference in induced stress responses of the upper edge 11 and lower edge 13 to the same external loading condition. When the glass sheet article 1 having the properties described above is installed for use, the surface with the edge having the lower induced stress response to external loading would be the surface most suitable for exposure to external abuse. In the case of the surfaces 5, 7, the surface with the edge having the lower induced stress response to external loading would be the lower surface 7 because the lower edge 13 of the lower surface 7 has the larger radius of curvature out of the two edges 11, 13.

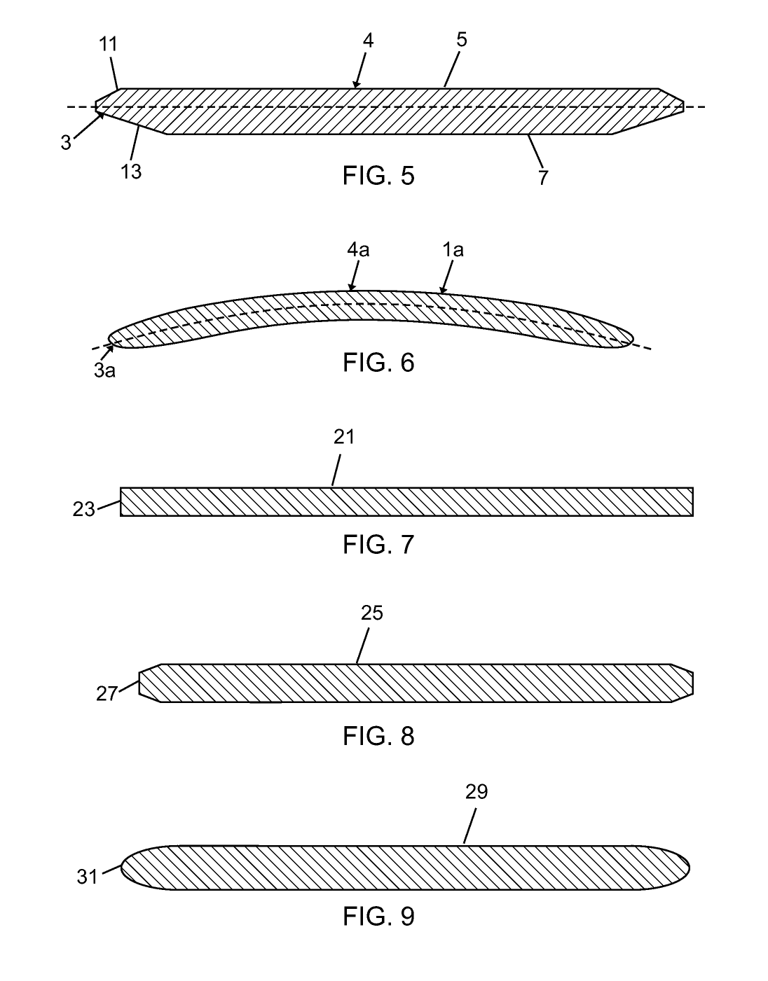

FIG. 2 shows an embodiment where the tapered upper edge 11 and the tapered lower edge 13 are both curved. However, other embodiments are possible. For example, as shown in FIG. 4, the tapered upper edge 11 may be beveled or chamfered while the tapered lower edge 13 is curved (or, although not shown FIG. 4, the tapered lower edge 13 may be beveled or chamfered while the tapered upper edge 11 is curved). In another example, as shown in FIG. 5, both the tapered upper edge 11 and the tapered lower edge 13 may be beveled. It should be noted that beveled edges would be inferior to curved edges in terms of stress concentration, with beveled edges having sharp corners at which stress can concentrate, while curved edges won't have such sharp corners. It is also possible to form either or both of the tapered upper edge 11 and the tapered lower edge 13 using a combination of curved and straight edge sections, a combination of curved and angled edge sections, or a combination of curved, straight, and angled edge sections. In general, such combinations of curved, straight, and angled edge sections will be regarded as curved edges. Regardless of the shapes used in constructing the upper edge 11 and lower edge 13, the upper edge 11 and lower edge 13 would have different taper profiles, as mentioned above, in order to form the double-tapered asymmetric edge 3.

In FIGS. 1 through 5, the glass sheet 4 is shown as flat. In other embodiments of the present invention, the glass sheet 4 may be curved. FIG. 6 shows a cross-section of a curved glass sheet article 1a including a curved glass sheet 4a with a double-tapered asymmetric edge 3a. It should be noted that the thickness of the glass sheet 4 (or 4a) in FIGS. 2, 3, and 4-6 is intentionally exaggerated to make it easier to see the shape of the double-tapered asymmetric edge 3 (or 3a).

The glass sheet 4 may be made of a glass material having a suitable glass composition for the desired application. In certain aspects of the present invention, the glass is an ion-exchangeable glass, e.g., an alkali-containing glass capable of being strengthened by ion-exchange. The ion-exchangeable glass has a structure that initially contains small alkali ions, such as Li⁺, Na⁺, or both, that can be exchanged for larger alkali ions, such as K⁺, during an ion-exchange process. Examples of suitable ion-exchangeable glasses are alkali-aluminosilicate glasses such as those described in U.S. patent application Ser. Nos. 11/888,213, 12/277,573, 12/392,577, 12/393,241, and 12/537,393; U.S. Provisional Patent Application Nos. 61/235,767 and 61/235,762 (all assigned to Corning Incorporated), the contents of which are incorporated herein by reference in their entirety. These glasses can be ion-exchanged at relatively low temperatures and to a depth of at least 30 μm.

In one embodiment, the alkali-containing glass comprises: 60-72 mol % SiO₂; 9-16 mol % Al₂O₃; 5-12 mol % B₂O₃; 8-16 mol % Na₂O; and 0-4 mol % K₂O, wherein the ratio

$$\frac{{Al}_{2} {O}_{3} ( mol \% ) + {B}_{2} {O}_{3} ( mol \% )}{\sum alkali metal modifiers ( mol \% )} > 1 ,$$

where the alkali metal modifiers are alkali metal oxides.

In another embodiment, the alkali-containing glass comprises: 61-75 mol % SiO₂; 7-15 mol % Al₂O₃; 0-12 mol % B₂O₃; 9-21 mol % Na₂O; 0-4 mol % K₂O; 0-7 mol % MgO; and 0-3 mol % CaO.

In yet another embodiment, the alkali-containing glass comprises: 60-70 mol % SiO₂; 6-14 mol % Al₂O₃; 0-15 mol % B₂O₃; 0-15 mol % Li₂O; 0-20 mol % Na₂O; 0-10 mol % K₂O; 0-8 mol % MgO; 0-10 mol % CaO; 0-5 mol % ZrO₂; 0-1 mol % SnO₂; 0-1 mol % CeO₂; less than 50 ppm As₂O₃; and less than 50 ppm Sb₂O₃; wherein 12 mol %≦Li₂O+Na₂O+K₂O≦20 mol % and 0 mol %≦MgO+CaO≦10 mol %.

In still another embodiment, the alkali-containing glass comprises: 64-68 mol % SiO₂; 12-16 mol % Na₂O; 8-12 mol % Al₂O₃; 0-3 mol % B₂O₃; 2-5 mol % K₂O; 4-6 mol % MgO; and 0-5 mol % CaO, wherein: 66 mol %≦SiO₂+B₂O₃+CaO≦69 mol %; Na₂O+K₂O+B₂O₃+MgO+CaO+SrO>10 mol %; 5 mol %≦MgO+CaO+SrO≦8 mol %; (Na₂O+B₂O₃)−Al₂O₃≦2 mol %; 2 mol %≦Na₂O−Al₂O₃≦6 mol %; and 4 mol %≦(Na₂O+K₂O)−Al₂O₃≦10 mol %.

In some aspects of the present invention, the glass is chemically strengthened by ion exchange. A process for strengthening glass by ion-exchange is described in, for example, U.S. Pat. No. 5,674,790 (Araujo, Roger J.). The ion-exchange process typically occurs at an elevated temperature range that does not exceed the transition temperature of the glass. The process is carried out by immersing the glass in a molten bath containing an alkali salt (typically a nitrate) with ions that are larger than that of the host alkali ions in the glass. The host alkali ions are exchanged for the larger alkali ions. For example, a glass containing Na⁺ may be immersed in a bath of molten potassium nitrate (KNO₃). The larger K⁺ present in the molten bath will replace the smaller Na⁺ in the glass. The presence of the larger alkali ions at sites formerly occupied by small alkali ions creates a compressive stress at or near the surface of the glass and tension in the interior of the glass. The glass is removed from the molten bath and cooled down after the ion-exchange process. The ion-exchange depth, i.e., the penetration depth of the invading larger alkali ions into the glass, is typically on the order of 40 μm to 300 μm and is controlled by the glass composition and immersion time. When the ion-exchange process is properly executed, a scratch-resistant glass surface can be formed.

A study was carried out to determine how the glass sheet article 1 having a double-tapered asymmetric edge connecting the upper and lower surfaces of a glass sheet, as described above, responds to loading conditions. The response of the glass sheet article 1 (in FIG. 2) was compared to other types of glass sheet articles. FIG. 7 shows a glass sheet article 21 with a straight edge 23 connecting the upper and lower surfaces of the glass sheet. FIG. 8 shows a glass sheet article 25 with a symmetric chamfered edge 27 connecting the upper and lower surfaces of the glass sheet. FIG. 9 shows a glass sheet article 29 with a symmetric bull nose edge 31 connecting the upper and lower surfaces of the glass sheet. Glass sheet articles 21, 25, 29 are the other types of glass sheet articles considered in the study. Glass sheet articles 21, 25, 29 are presented herein only as comparative examples and may not necessarily be prior art.

The study included ion-exchange modeling, four-point bending modeling, and edge-drop modeling, and was carried out using finite element analysis (FEA). ABACUS was used for the finite element analysis. In general, FEA has two major parts: preprocessing and post-processing. During preprocessing, the geometry needed for the FEA is created. Then, a mesh is created for the geometry and a material property is applied to the mesh, as is well known in FEA. Appropriate initial conditions, boundary conditions, loadings, and constraints are applied to the mesh, and the FEA is then run. Post-processing involves reading the results (deformation, stress, energy) and creating plots based on the results.

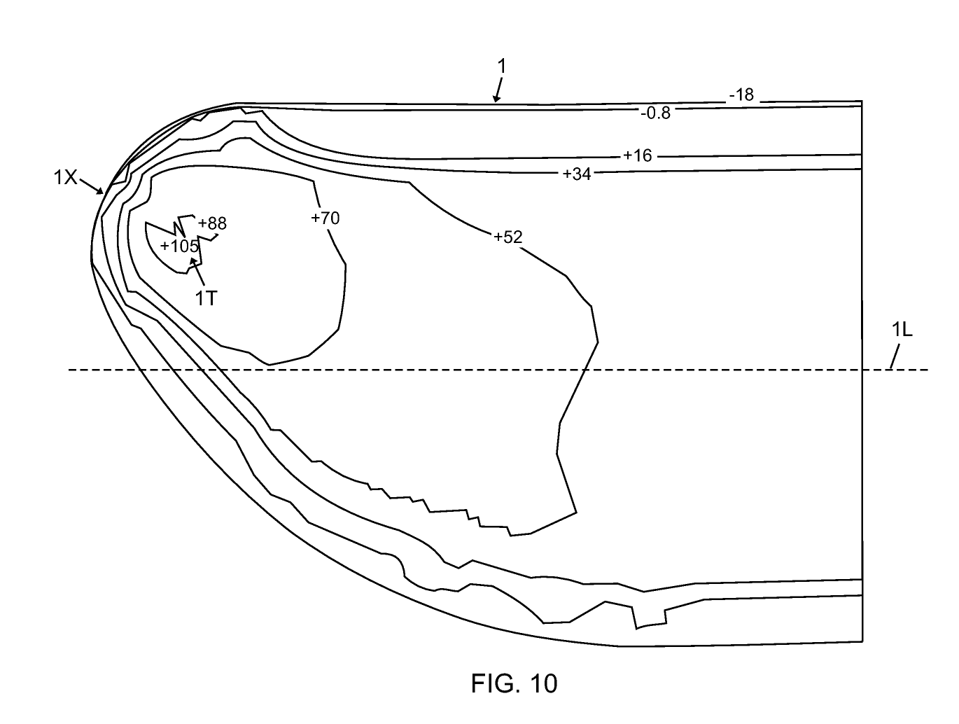

In a first instance, glass sheet articles 1, 21, 25, and 29 were modeled under ion-exchange process conditions (13.23 mole % surface concentration, 8 hours). As indicated above, ion-exchange results in compressive stress and tensile stress in the glass. Stress distributions obtained from the modeling are shown in FIGS. 10-13. In FIGS. 10-13, the “+” sign indicates tensile stress, while the “−” sign indicates compressive stress, and all stresses are expressed in MPa and rounded off.

FIG. 10 shows the maximum principal stress distribution in the glass sheet article 1 (which has a double-tapered asymmetric edge). In FIG. 10, there are compressive stresses at and near the surface of the glass sheet article 1. There are tensile stresses in the interior of the glass sheet article 1. There is tensile stress near the edge surface 1X of the glass sheet article 1, but this tensile stress is low, e.g., about +16 MPa. The peak tensile stress region is indicated at 1T. The peak tensile stress observed in the interior of the glass sheet article 1 is about +105 MPa. The peak compressive stress observed at the surface of the glass sheet article 1 is about −107 MPa (this is a very thin region at the surface and is not visible in FIG. 10). High compressive stress at the surface is desirable for resistance to damage.

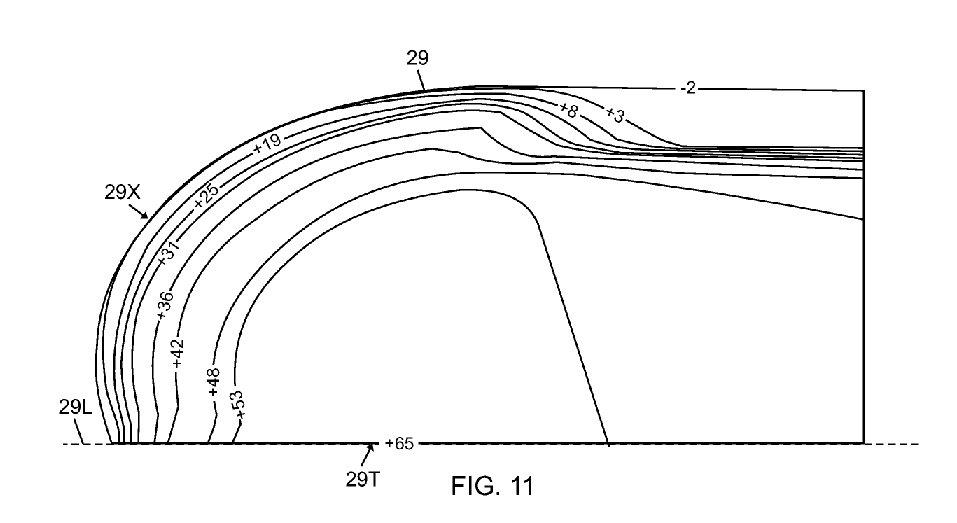

FIG. 11 shows the maximum principal stress distribution in the glass sheet article 29 (which has a symmetric bull nose edge). Only half of the geometry is shown in FIG. 11. The dashed line 29L indicates the centerline of the full geometry. Stress distribution for the full-geometry can be obtained by simply creating a mirror image of the stress distribution for the half-geometry about the centerline 29L. In FIG. 11, there are compressive stresses at and near the surface of the glass sheet article 29 and tensile stresses in the interior of the glass sheet article 29. The peak tensile stress region is indicated at 29T. The peak tensile stress observed in the interior of the glass sheet article 29 is about +65 MPa. The peak compressive stress observed at the surface of the glass sheet article 29 is about −2 MPa (compare this to -107 MPa for the glass sheet article 1). In glass sheet article 29, tensile stress near the edge surface 29X is about +3 MPa.

The peak tensile stress observed in the glass sheet article 29 (FIG. 11) is lower than the peak tensile stress observed in the glass sheet article 1 (FIG. 10). In the glass sheet article 29, the peak tensile stress region 29T is symmetric about the centerline 29L, i.e., located on both sides of the centerline 29L. In the glass sheet article 1, the peak tensile stress region 1T is located on one side of the centerline 1L of the geometry. Note that in FIG. 10, on the other side of the centerline 1L not including the peak tensile stress region 1T, the peak tensile stress is not greater than +70 MPa. For the glass sheet article 1, it is possible to select the profile of the double-tapered asymmetric edge such that the highest tensile stress on the other side of the centerline 1L not including the region 1T is much less than +70 MPa (i.e., comparable to or better than the bull nose case). Having the peak tensile stress region 1T on only one side of the centerline 1L, as in the case of the glass sheet article 1 (FIG. 10), is potentially beneficial for dynamic damage resistance. For the glass sheet article 1, the other side of the centerline 1L with the low tensile stresses (i.e., the side not including 1T) can be the “good” side that can be exposed to external abuse when the glass sheet article 1 is in use.

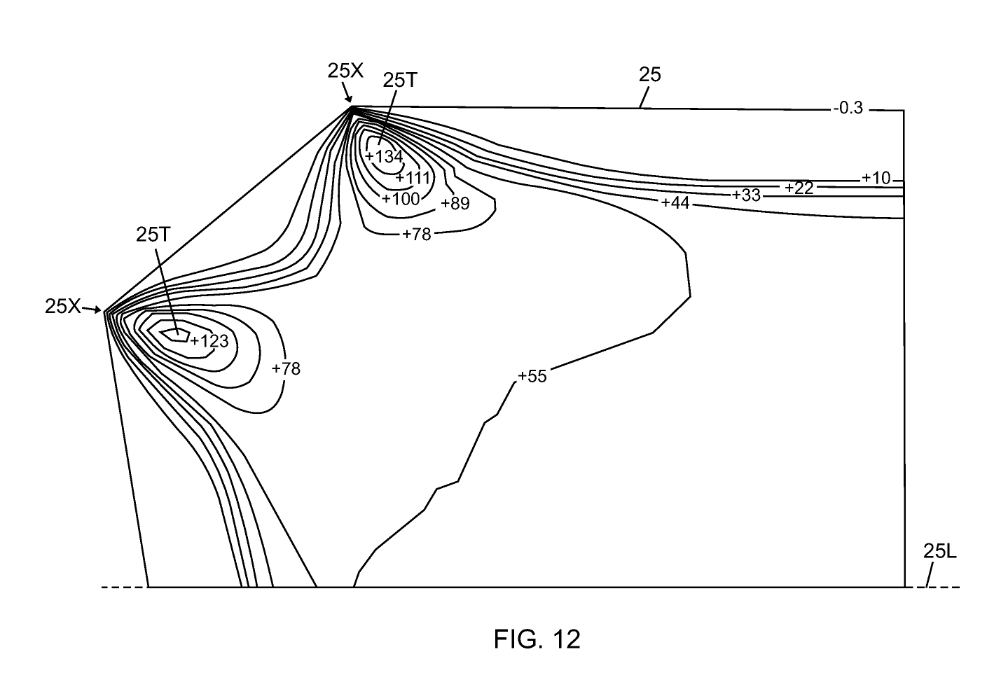

FIG. 12 shows the maximum principal stress distribution in the glass sheet article 25 (which has the symmetric chamfered edge). Only half of the geometry is shown in FIG. 12. The dashed line 25L indicates the centerline of the full geometry. The stress distribution for the full-geometry can be obtained by simply creating a mirror image of the stress distribution for the half-geometry about the centerline 25L. In FIG. 12, there are compressive stresses at and near the surface of the glass sheet article 25 and tensile stresses in the interior of the glass sheet article 25. However, note that tensile stress concentrates at the external corners 25X of the glass sheet article 25. The peak tensile stress regions are indicated at 25T. Note how the regions 25T are very close to the external corners 25X. The peak tensile stress observed in the glass sheet article 25 is about +134 MPa, which is much higher than the peak tensile stresses observed in the glass sheet article 1 (FIG. 10). The peak compressive stress observed at the surface of the glass sheet article 25 is −0.3 MPa, which is much lower than the peak compressive stress of −107 MPa observed at the surface of the glass sheet article 1 (FIG. 10).

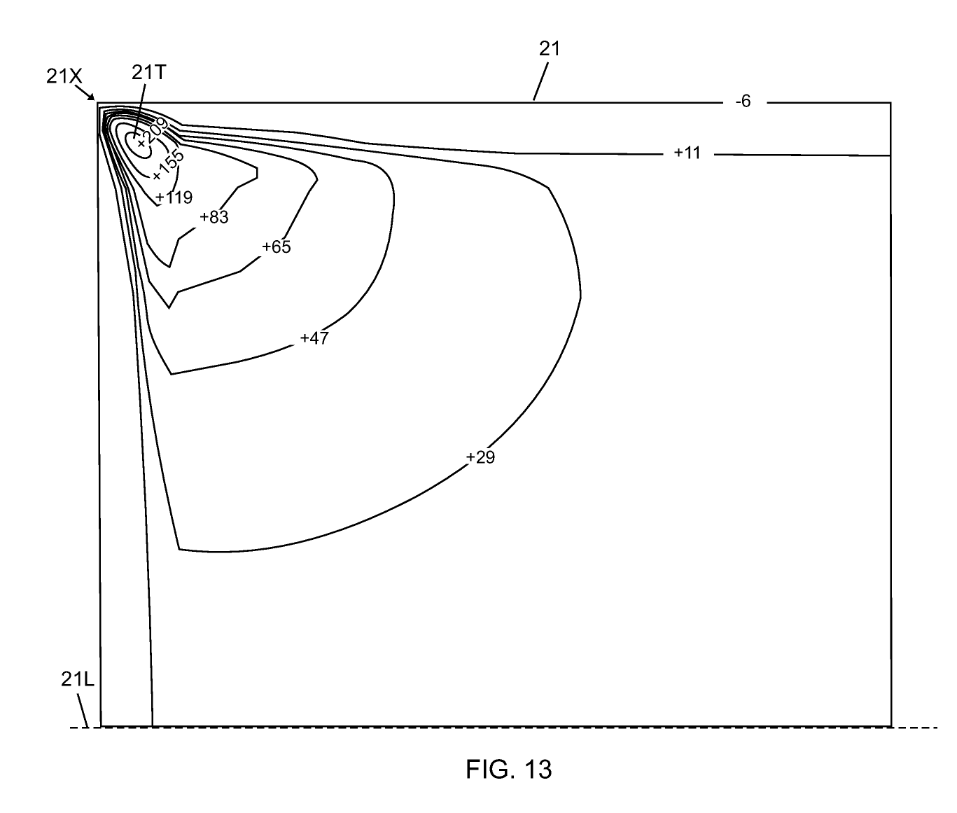

FIG. 13 shows the maximum principal stress distribution in the glass sheet article 21 (which has the straight edge). Only half of the geometry is shown in FIG. 13. The dashed line 21L indicates the centerline of the full geometry. The stress distribution for the full-geometry can be obtained by simply creating a mirror image of the stress distribution for the half-geometry about the centerline 21L. In FIG. 11, there are compressive stresses at and near the surface of the glass sheet article 21 and tensile stresses in the interior of the glass sheet article 21. Note that the tensile region extends right to the external corner 21X of the glass sheet article 21, which would make the glass sheet article 21 vulnerable to damage at the external corner 21X. The peak tensile stress region is indicated at 21T. Note how this region is very close to the external corner 21X. The peak tensile stress observed in the glass sheet article 21 is about +209 MPa, which is much higher than the peak tensile stresses observed in the glass sheet article 1 (FIG. 10), glass sheet article 29 (FIG. 11), and glass sheet article 25 (FIG. 12). The peak compressive stress observed at the surface of the glass sheet article 21 is about −6 MPa, which is much lower than the peak compressive stress of −107 MPa observed at the surface of the glass sheet article 1 (FIG. 10).

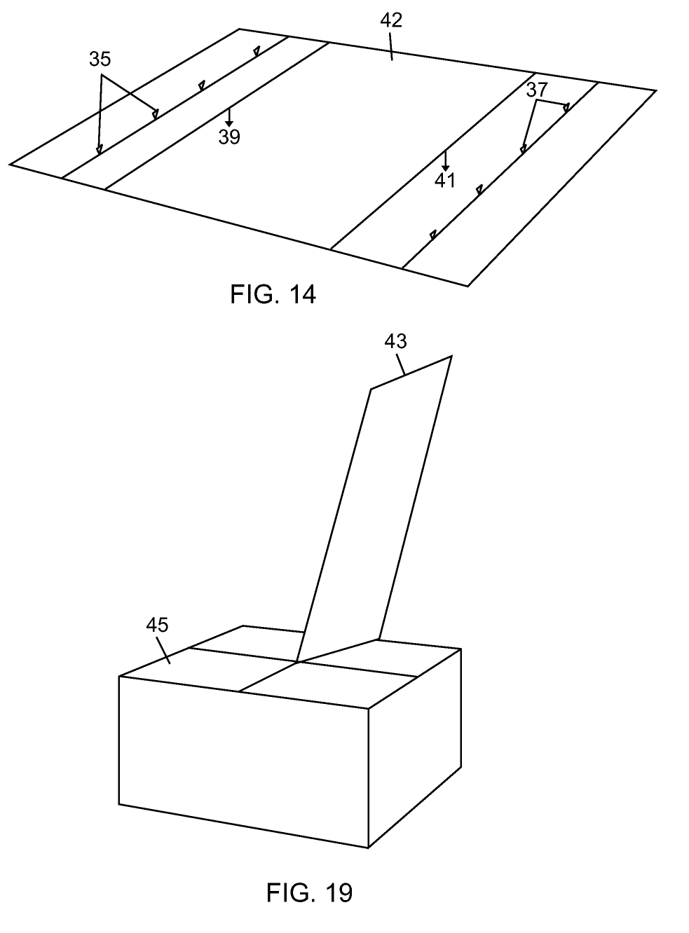

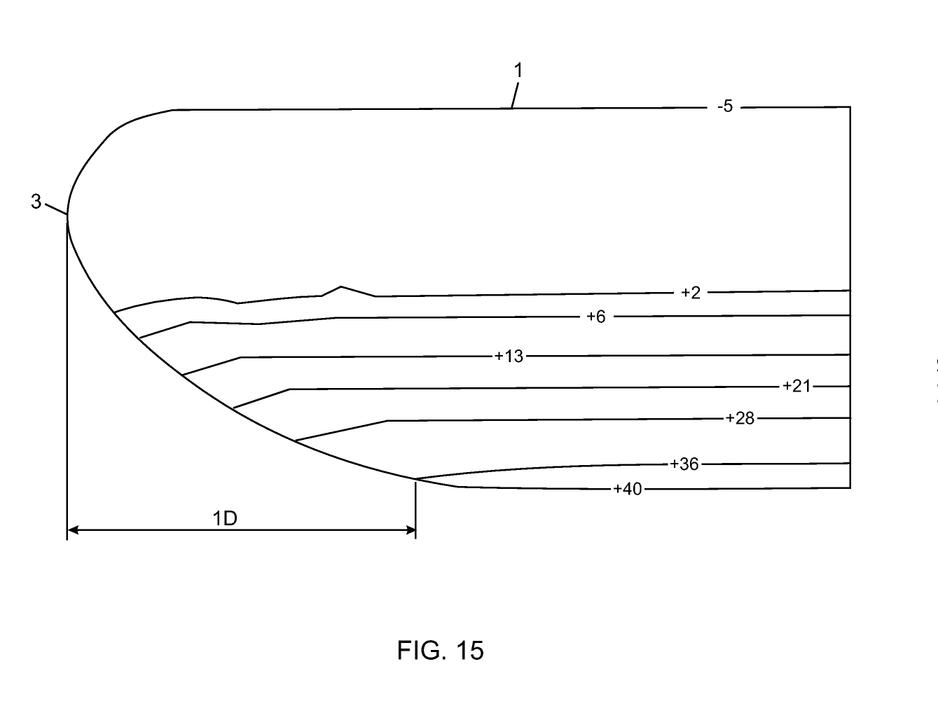

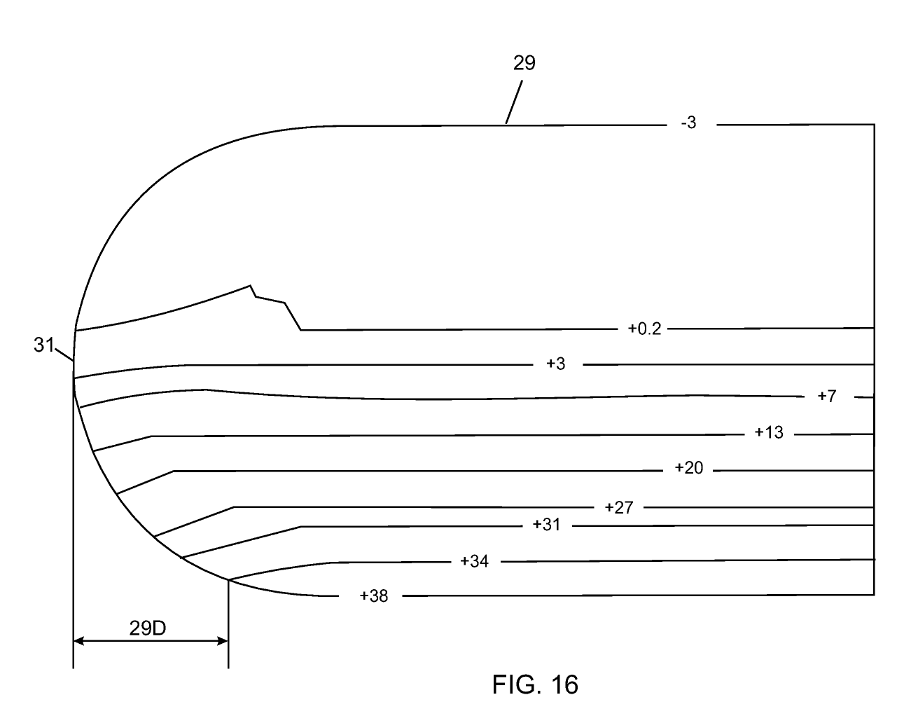

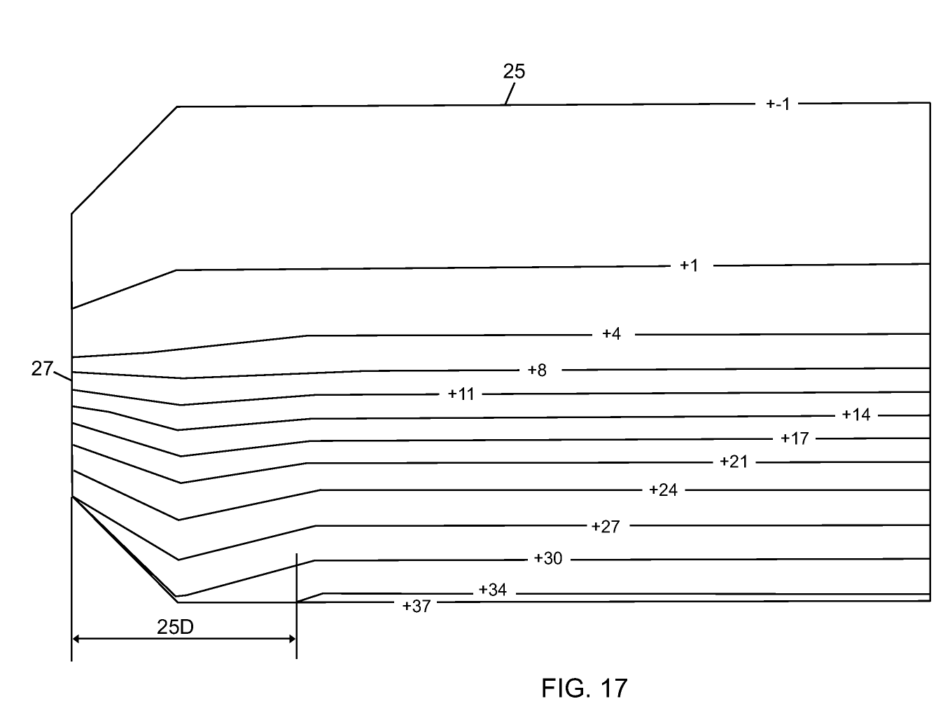

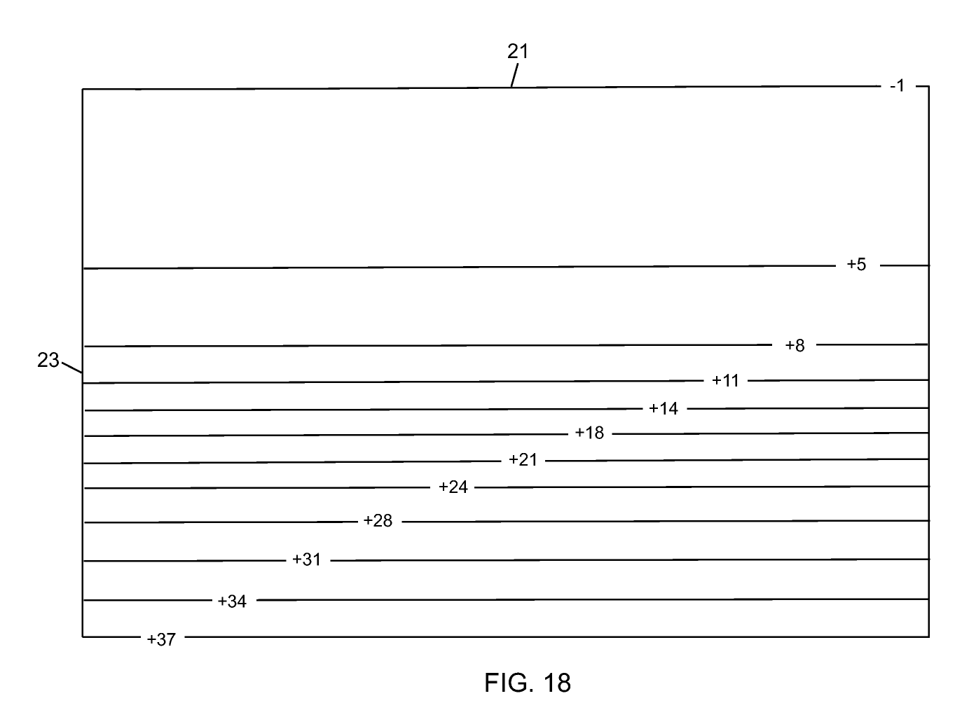

In a second instance, glass sheet articles 1, 21, 25, and 29 were modeled under four-point bending conditions. FIG. 14 illustrates the test model. In FIG. 14, triangles 35, 37 represent support of a glass sheet article 42 (which represents any of glass sheet articles 1, 21, 25, and 29), and arrows 39, 41 represent application of downward force to the glass sheet article 42. For the study, a downward force of 20N was applied at 39, 41. FIG. 15 shows the stress results for the glass sheet article 1. FIG. 16 shows the stress results for the glass sheet article 29. FIG. 17 shows the stress results for the glass sheet article 25. FIG. 18 shows the stress results for the glass sheet article 21. In FIGS. 15-18, the “+” sign indicates tensile stress, while the “−” sign indicates compressive stress, and all stresses are expressed in MPa.

In FIG. 15, the peak tensile stress observed in the glass sheet article 1 (with double-tapered asymmetric edge) is about +40 MPa. The offset of this peak tensile stress from the edge 3 of the glass sheet article 1 is indicated by 1D. In FIG. 16, the peak tensile stress observed in the glass sheet article 29 (with symmetric bull nose edge) is about +38 MPa. The offset of this peak tensile stress from the edge 31 of the glass sheet article 29 is indicated by 29D. Note that 29D in FIG. 16 is much smaller than 1D in FIG. 15. In FIG. 17, the peak tensile stress observed in the glass sheet article 25 (with symmetric chamfered edge) is about +37 MPa. The offset of this peak tensile stress from the edge 27 of the glass sheet article 25 is indicated by 25D. Note that 25D in FIG. 17 is much smaller than 1D in FIG. 15. In FIG. 18, the peak tensile stress observed in the glass sheet article 21 (with straight edge) is about +37 MPa. The offset of this peak tensile stress from the edge 23 of the glass sheet article 21 is 0. In general, there are no significant differences in terms of peak stress amplitude in the stress responses of the articles 1, 21, 25, and 29. However, the peak stress location in the case of glass sheet article 1 with the double-tapered asymmetric edge is pushed further back into the surface region (as indicated by the offset 1D in FIG. 15) compared to the glass sheet articles 29, 25, 21. Pushing the peak stress region from the edge into the higher-strength surface region will help to take full advantage of the surface strength and improve mechanical performance.

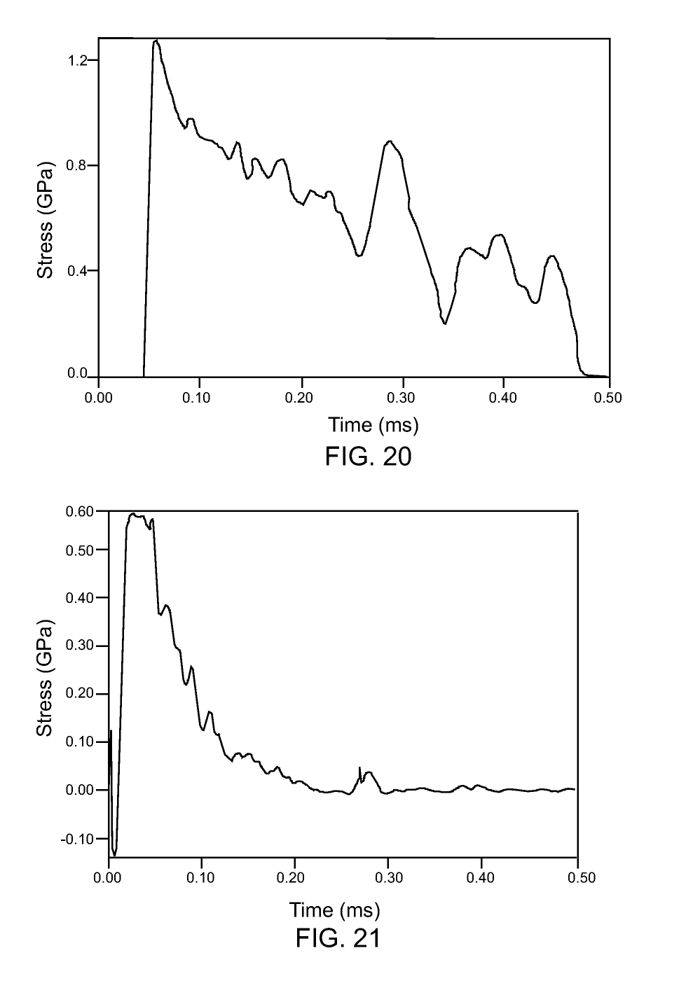

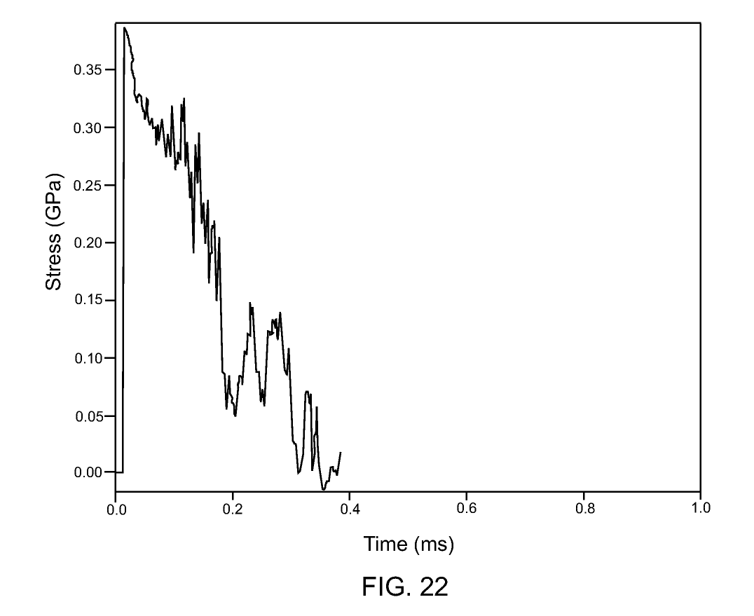

In a third instance, glass sheet articles 1, 21, 25, and 29 were modeled under edge drop conditions. The drop test was conducted to evaluate dynamic performance. FIG. 19 shows the test model. In FIG. 19, a glass sheet article 43 (which represents any one of glass sheet articles 1, 25, and 29) is dropped on a granite block 45. For the simulation, the glass sheet article 43 had an elastic stiffness of 72.897 GPa, Poisson's ratio of 0.211, and density of 2461 kg/m³. The granite block 45 had an elastic stiffness of 60 GPa, Poisson's ratio of 0.27, and density of 2600 kg/m³. An arbitrary orientation was chosen for the drop, and the glass was dropped on the granite from a height of 1 meter. The stress results are shown in FIGS. 20-22 for articles 25, 29, and 1, respectively. For the glass sheet article with the symmetric chamfered edge (FIG. 20), peak stress was greater than 1.2 GPa. For the glass sheet article with the symmetric bull nose edge (FIG. 21), peak stress was less than 0.6 GPa. For the glass sheet article with the double-tapered asymmetric edge (FIG. 20) (as in aspects of the present invention), peak stress was less than 0.4 GPa.

A method of making the glass sheet article 1 with the double-tapered asymmetric edge may include providing or making a glass sheet having an upper surface and a lower surface, where the upper surface has an upper edge and the lower surface has a lower edge. Such a glass sheet can be made using any suitable process, e.g., down-draw, fusion, float glass processes, or the like. The glass sheet may be in any desired shape. The upper edge is tapered towards the lower edge using a first taper profile. Also the lower edge is tapered towards the upper edge using a second taper profile. Such tapering may be accomplished by appropriate techniques, such as machining techniques known in the art. The taper profiles may be curved or beveled as described above. The tapering should be such that the upper edge and lower edge intersect to form a double-tapered asymmetric edge. After forming the double-tapered asymmetric edge, the glass sheet article may be subjected to an ion-exchange process in order to strengthen the glass sheet article. In addition to or in lieu of the ion-exchange process, a glass coating may be applied on the glass sheet article. A glass coating containing titanium-doped silica may be used. This could improve the surface strength of the glass sheet article.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A glass sheet article, comprising:
a glass sheet having an upper surface and a lower surface, wherein:
the upper surface terminates in a tapered upper edge and the lower surface terminates in a tapered lower edge;
a taper profile of the tapered upper edge is different from a taper profile of the tapered lower edge; and
the tapered upper edge and the tapered lower edge intersect to form a double-tapered asymmetric edge.

2. The glass sheet article of claim 1, wherein an induced stress response of the tapered upper edge to a loading condition is different from an induced stress response of the tapered lower edge to the same loading condition.

3. The glass sheet article of claim 1, wherein at least one of the tapered upper edge and tapered lower edge is curved.

4. The glass sheet article of claim 3, wherein the tapered upper edge and the tapered lower edge are both curved.

5. The glass sheet article of claim 1, wherein at least one of the tapered upper edge and tapered lower edge is beveled.

6. The glass sheet article of claim 1, wherein the glass sheet is flat.

7. The glass sheet article of claim 1, wherein the glass sheet is curved.

8. The glass sheet article of claim 1, wherein the glass sheet is asymmetric when viewed from at least one of the upper surface and the lower surface.

9. The glass sheet article of claim 1, wherein the glass sheet is made of an alkali-containing glass.

10. The glass sheet article of claim 9, wherein the alkali-containing glass comprises: 60-72 mol % SiO₂; 9-16 mol % Al₂O₃; 5-12 mol % B₂O₃; 8-16 mol % Na₂O; and 0-4 mol % K₂O, wherein the ratio
$$\frac{{Al}_{2} {O}_{3} ( mol \% ) + {B}_{2} {O}_{3} ( mol \% )}{\sum alkali metal modifiers ( mol \% )} > 1 ,$$
where the alkali metal modifiers are alkali metal oxides.

11. The glass sheet article of claim 9, wherein the alkali-containing glass comprises: 61-75 mol % SiO₂; 7-15 mol % Al₂O₃; 0-12 mol % B₂O₃; 9-21 mol % Na₂O; 0-4 mol % K₂O; 0-7 mol % MgO; and 0-3 mol % CaO.

12. The glass sheet article of claim 9, wherein the alkali-containing glass comprises: 60-70 mol % SiO₂; 6-14 mol % Al₂O₃; 0-15 mol % B₂O₃; 0-15 mol % Li₂O; 0-20 mol % Na₂O; 0-10 mol % K₂O; 0-8 mol % MgO; 0-10 mol % CaO; 0-5 mol % ZrO₂; 0-1 mol % SnO₂; 0-1 mol % CeO₂; less than 50 ppm As₂O₃; and less than 50 ppm Sb₂O₃; wherein 12 mol %≦Li₂O+Na₂O+K₂O≦20 mol % and 0 mol %≦MgO+CaO≦10 mol %.

13. The glass sheet article of claim 9, wherein the alkali-containing glass is chemically strengthened by ion exchange.

14. The glass sheet article of claim 1, wherein the glass sheet is coated with a glass coating.

15. The glass sheet article of claim 14, wherein the glass coating comprises titanium-doped silica.

16. A method of making a glass sheet article, comprising:
providing a glass sheet having an upper surface and a lower surface, the upper surface having an upper edge, the lower surface having a lower edge;
tapering the upper edge towards the lower edge using a first taper profile; and
tapering the lower edge towards the upper edge using a second taper profile, the second taper profile being different from the first taper profile, the upper edge and the lower edge intersecting to form a double-tapered asymmetric edge.

17. The method of claim 16, further comprising chemically strengthening the glass sheet with the double-tapered asymmetric edge by an ion-exchange process.
